(19) United States
(12) Patent Application Publication
(10) Pub. No.: US 2016/0247196 A1
(43) Pub. Date: Aug. 25, 2016

(54) Rendering user interfaces that dynamically present content-based information extracted from images

(71) Applicant: GOOGLE INC., Mountain View, CA (US)

(72) Inventor: Kawaljit Gandhi, San Francisco, CA (US)

(21) Appl. No.: 15/144,766

(22) Filed: May 2, 2016

Related U.S. Application Data
(63) Continuation of application No. 13/025,837, filed on Feb. 11, 2011.

(51) Int. Cl. G06Q 30/02; H04N 7/18; H04W 4/12; G06K 9/18; H04W 4/02; H04W 4/18

(52) U.S. Cl. CPC G06Q 30/0255; H04W 4/025; H04W 4/185; H04W 4/12; H04W 4/023; G06K 9/18; H04N 7/185; G06Q 30/0267

(57) ABSTRACT

Causing a mobile computing device to render a user interface that presents content that is selected based on information extracted from images comprises analyzing an image by performing an OCR process and extracting converted text. A camera on the device captures an image. The device monitors its location, detects a location at a time when the image is captured, and associates the location with the image. The device analyzes the image by performing an OCR process on the image, extracts information from converted text, and determines the associated location. The extracted information, the location, and a request for content are transmitted to a content distribution system, which selects the content. The content distribution system transmits an alert notification to the device that causes an alert to display on the user interface. When the content alert is selected, the user interface is rendered to present content available near the location.

### RELATED APPLICATIONS

This application is a continuation of U.S. patent application Ser. No. 13/025,837 filed Feb. 11, 2001, entitled “Providing Content Based on Receipt Information.” The entire contents of the above-identified priority application are hereby fully incorporated herein by reference.

### TECHNICAL FIELD

The present disclosure relates generally to extracting information from images using an optical character recognition (“OCR”) process, and more particularly to dynamically presenting content that is selected based on information extracted from images using an OCR process and a geolocation associated with the images.

### BACKGROUND

In many different environments, content providers want to provide content to individuals. In some instances, a content provider may rely on contextual information when making decisions regarding selections of content to provide to an individual. Therefore, it is desirable to provide a mechanism for providing content to the recipient based on the individual's perceived needs.

### SUMMARY

In certain example embodiments, a method to cause a mobile computing device to render a user interface that dynamically presents content that is selected based on information extracted from images comprises analyzing an image by performing an optical character recognition (“OCR”) process on the image and extracting converted text from the image. A camera on the mobile computing device captures an electronic image and a geolocation is associated with the image. The mobile computing device monitors locations of the mobile computing device and automatically detects a location of the mobile computing device at a time when the camera captures the image. The associated geolocation comprises the location of the mobile computing device at the time when the camera captured the image. The mobile computing device analyzes the image by performing an OCR process on the image, extracting information from converted text of the image, and determining the geolocation associated with the image. The extracted information, the geolocation, and a request for content are transmitted to a content distribution computing system. The content distribution computing system determines content for transmission to the mobile computing device by analyzing the extracted information, the geolocation, and the request for content. The content distribution computing system transmits a content alert notification to the mobile computing device. The content alert notification causes a content alert to display on the user interface on the mobile computing device. The content alert notifies the user of the mobile computing device that content is available for display based on the user interface. The user interface on the mobile computing device is rendered to present the content available near the geolocation when the content alert is selected.

In certain exemplary embodiments, a system to render a user interface to dynamically present content that is selected based on information extracted from images comprises analysis of an image by performing an OCR process on the image and extracts converted text from the image. The system comprises a mobile computing device and a content distribution computing device. The mobile computing device comprises a processor, a storage device, a user interface that is rendered to dynamically present content, a camera that captures an electronic image, and a location device that associates a geolocation with the image. The location device monitors locations of the mobile computing device and detects a location of the mobile computing device at a time when the camera captures the image. The mobile computing device analyzes the image by performing an OCR process on the image, extracts information from converted text of the image, and determines the geolocation associated with the image. The content distribution computing device receives the extracted information, the geolocation, and a request for content from the mobile computing device, and determines content to select for transmission to the mobile computing device by analyzing the extracted information, the geolocation, and the request for content. The content distribution computing system transmits a content alert notification to the mobile computing device. The content alert notification causes a content alert to display on the user interface on the mobile computing device. The content alert notifies the user of the mobile computing device that content is available for display based on the user interface. The user interface on the mobile computing device is rendered to present the content available near the geolocation when the content alert is selected.

In certain exemplary embodiments, a computer program product that comprises a non-transitory computer-readable medium having computer-executable program code embodied thereon that when executed by a mobile computing device causes the mobile computing device to render a user interface to dynamically present content selected based on information extracted from images. The computer program product comprises computer-executable program code to analyze an image by performing an OCR process on the image and extract converted text from the image. The computer program product comprises computer-executable program code to capture an electronic image and associate a geolocation with the image. The mobile computing device monitors locations of the mobile computing device and detects a location of the mobile computing device at a time when the image is captured. The computer program product further comprises computer-executable program code to analyze the image by performing an OCR process on the image, extract information from converted text of the image, and determine the geolocation associated with the image. The extracted information, the geolocation, and a request for content are transmitted to a content distribution computing system. The content distribution computing system determines content to select for transmission to the mobile computing device by analyzing the extracted information, the geolocation, and the request for content. The content distribution computing system transmits a content alert notification to the mobile computing device. The content alert notification causes a content alert to display on the user interface on the mobile computing device. The content alert notifies the user of the mobile computing device that content is available for display based on the user interface. The computer program product further comprises computer-executable program code to render the user interface on the mobile computing device to present the content available near the geolocation when the content alert is selected.

These and other aspects, objects, features, and advantages of the exemplary embodiments will become apparent to those having ordinary skill in the art upon consideration of the following detailed description of illustrated exemplary embodiments, which include the best mode of carrying out the invention as presently perceived.

### BRIEF DESCRIPTION OF THE DRAWINGS

FIG. 1 depicts a system for providing content, in accordance with certain exemplary embodiments.

FIG. 2 is a block flow diagram depicting a method for providing content, in accordance with certain exemplary embodiments.

FIG. 3 is a block flow diagram depicting a method for determining whether an image file includes a receipt, in accordance with certain exemplary embodiments.

FIG. 4 is a block diagram depicting an end user network device displaying an image having a receipt, in accordance with certain exemplary embodiments.

FIG. 5 is a block diagram depicting an end user network device displaying an image having a receipt and a multitude of icons for requesting additional content.

FIG. 6 is a block diagram depicting an end user network device displaying deals or promotions, in accordance with certain exemplary embodiments.

FIG. 7 is a block diagram depicting an end user network device displaying services, in accordance with certain exemplary embodiments.

FIG. 8 is a block diagram depicting an end user network device displaying prices of products at other merchants, in accordance with certain exemplary embodiments.

### DETAILED DESCRIPTION OF THE EXEMPLARY EMBODIMENTS

Overview

The method and system described herein enables a content provider to provide content to a recipient based on information obtained from one or more receipts or transaction records documenting a prior purchase transaction. The system includes a content distribution system, implemented in hardware and/or software. The content distribution system receives content and information from content providers, such as merchants, product manufacturers, and advertisers. Generally, this content can include advertisements, promotional offers, coupons, product brochures, training videos, information regarding product accessories, and product pricing information. As used throughout this specification, the term “product” should be interpreted to include tangible and intangible products, as well as services.

A selection engine of the content distribution system can select content to provide to a recipient based on information obtained from one or more of the recipient's receipts or other document or record that documents a prior purchase transaction of an item, such as a product or service. A receipt analysis module resident on a user device (or at the selection engine) can analyze an image file to determine whether the image file includes a receipt and extract information from the receipt. The user device can send this extracted information to the content distribution system and request content based on the sent information. For example, an individual can use a camera installed on a smartphone to capture an image of a paper receipt received for the purchase of a television. The receipt module running on the smartphone can determine that the captured image contains a receipt and extract information from the receipt. The receipt module also can send the extracted information to the content distribution system. The selection engine of the content distribution system can identify content associated with the purchased television and send the identified content to the user's smartphone for presentation to the user. For example, the content can include the price of the television at other retailers nearby or at an online merchant, a brochure for the television, a coupon for a related product or accessory to the television, such as a Blu-ray disc player, or information regarding a competing product, such as a television offered by a different manufacturer.

Users may be allowed to limit or otherwise affect the operation of the features disclosed in the specification. For example, users may be given opportunities to opt-in or opt out of the collection or use of certain data or the activation of certain features. In addition, users may be given the opportunity to change the manner in which the features are employed, including for situations in which users may have concerns regarding their privacy. Instructions also may be provided to users to notify them regarding policies about the use of information, including personally identifiable information, and manners in which they may affect such use of information. Thus, sensitive personal information can be used to benefit a user, if desired, through receipt of targeted advertisements or other information, without risking disclosure of personal information or the user's identity.

One or more aspects of the exemplary embodiments may include a computer program that embodies the functions described and illustrated herein, wherein the computer program is implemented in a computer system that comprises instructions stored in a machine-readable medium and a processor that executes the instructions. However, it should be apparent that there could be many different ways of implementing the exemplary embodiments in computer programming, and the exemplary embodiments should not be construed as limited to any one set of computer program instructions. Further, a skilled programmer would be able to write such a computer program to implement an embodiment based on the appended flow charts and associated description in the application text. Therefore, disclosure of a particular set of program code instructions is not considered necessary for an adequate understanding of how to make and use the exemplary embodiments. The functionality of the exemplary embodiments will be explained in more detail in the following description, read in conjunction with the figures illustrating the program flow.

Turning now to the drawings, in which like numerals indicate like (but not necessarily identical) elements throughout the figures, exemplary embodiments are described in detail.

### Example System Architectures

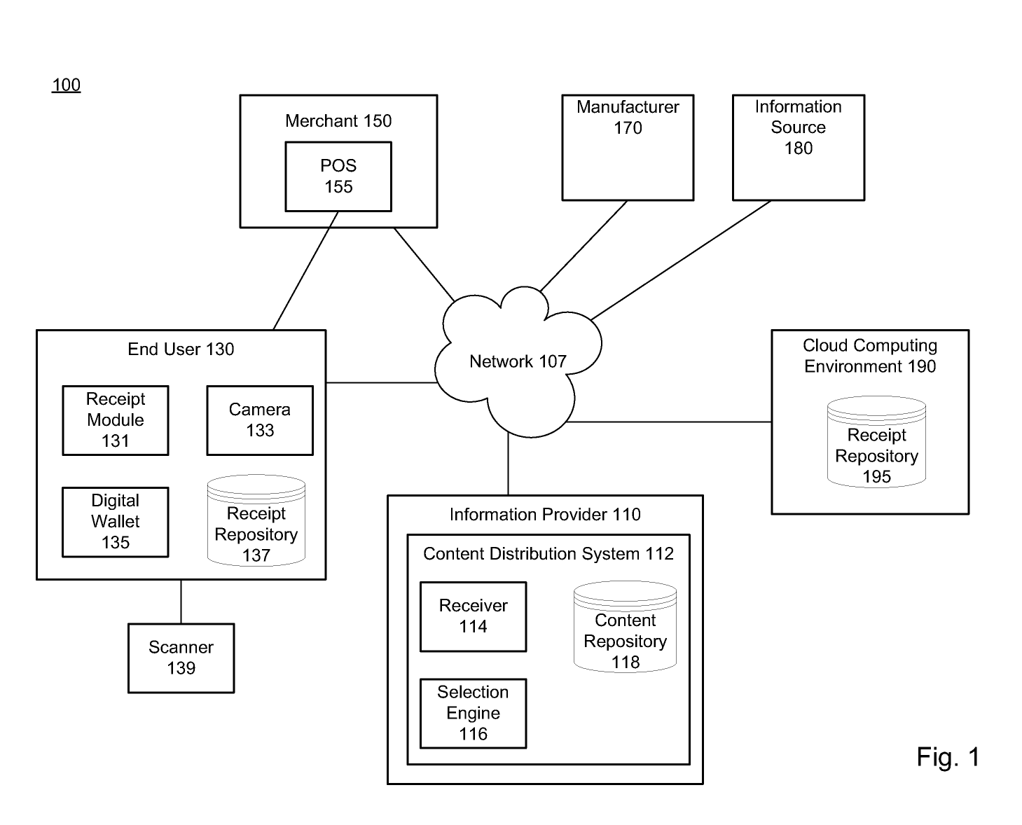

With reference to FIG. 1, a system 100 for providing content can be used to provide content to an individual based on an analysis of information obtained from one or more receipts. As depicted in FIG. 1, the system 100 includes network devices 110, 130, 150, 170, 180, 190 that are configured to communicate with one another via one or more networks 107. Each network 107 includes a wired or wireless telecommunication means by which network devices (including devices 110, 130, 150, 170, 180, 190) can exchange data. For example, each network 107 can include a local area network (“LAN”), a wide area network (“WAN”), an intranet, an Internet, a mobile telephone network, or any combination thereof. Throughout the discussion of exemplary embodiments, it should be understood that the terms “data” and “information” are used interchangeably herein to refer to text, images, audio, video, or any other form of information that can exist in a computer-based environment.

Each network device 110, 130, 150, 170, 180, 190 includes a device having a communication module capable of transmitting and receiving data over the network 107. For example, each network device 110, 130, 150, 170, 180, 190 can include a server, desktop computer, laptop computer, smartphone, handheld computer, personal digital assistant (“PDA”), or any other wired or wireless, processor-driven device. In the exemplary embodiment depicted in FIG. 1, the network devices 110, 130, 150, 170, 180, 190 are operated by an information provider, an end user, a merchant, a product manufacturer, an information provider, and a cloud computing provider, respectively.

The end user network devices 130 each include a receipt module 131 operable to analyze an image file for a document to determine whether the image file includes a receipt. The image file can include information to create an electronic image of a document, such as a receipt, or another object. The receipt module 131 is further operable to extract information from the identified receipt and store the receipt and extracted information in a receipt repository 137 stored on or coupled to the end user network device 130 and at a cloud computing environment 190. The end user network devices 130 also can include a camera 133 and a digital wallet 135. A user can capture an image of paper receipts using the camera 133 or a scanner 139 coupled to the end user network device 130. The scanner 139 can be communicably coupled to the end user network device 130 directly via a cable or via the network 107.

Image files also can include additional information, such as geolocation identifying the location at which the image was created and/or the location at which the receipt module 131 analyzed the image file and extracted information from the image file. The image file also can include time/date information identifying the time and/or date when the image was created and/or the time/date when the receipt module 131 analyzed the image file and extracted information from the image file. This additional information also can be extracted by the receipt module 131.

The receipt module 131 can send the extracted information to an information provider network device 110 with a request for content. The information provider network device 110 includes a content distribution system 112 having a selection engine 116 that selects content based at least on the received information and sends the selected content to the receipt module 131 for presentation to the user. This content can include text, graphics, images, sound, video, web page files, and other multimedia and data files that can be transmitted via the network 107. In certain exemplary embodiments, the selection engine 116 selects from available content stored in a content repository 118 maintained by the information provider network device 110. In certain exemplary embodiments, the selection engine 116 requests content from a merchant 150 or a manufacturer 170.

The end user network devices 130 also can each include a browser application module), such as Microsoft Internet Explorer, Firefox, Netscape, Google Chrome, or another suitable application for interacting with web page files maintained by the information provider network device 110 and/or other network devices. For example, the web page files 107 can include one or more files in the HyperText Markup Language (“HTML”). The browser application module can receive web page files from the information provider network device 110 and can display the web pages to an end user operating the end user network device 130.

In certain exemplary embodiments, the content distribution system 112 is resident on the end user network device 130. In such an offline embodiment, content can be presented to the user without sending receipt information over the network 107. In certain exemplary embodiments, the receipt module 131 is resident at the information provider network device 110 rather than the end user network device 130. In such an embodiment, the end user network device 130 can send an image file for a document containing a receipt to the information provider network device 110. In turn, the information provider network device 110 can send content to the end user network device 103 based on the contents of the receipt.

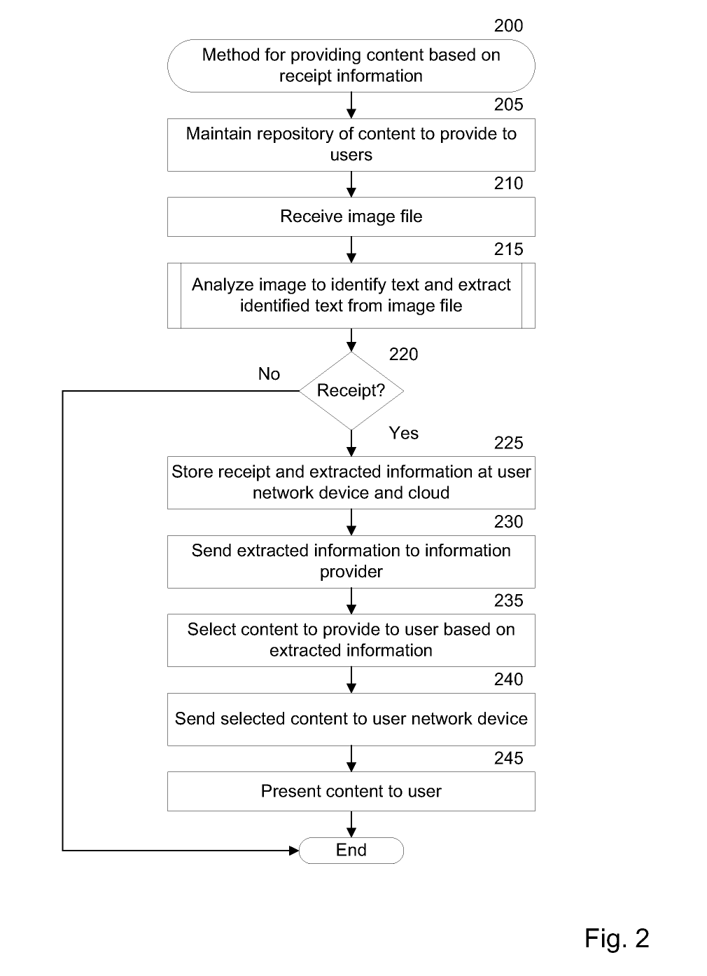

The content distribution system 112 and the receipt module 131 are described in more detail hereinafter with reference to the method illustrated in FIG. 2.

### Example System Processes

FIG. 2 is a block flow diagram depicting a method 200 for providing content based on an analysis of information obtained from one or more receipts, in accordance with certain exemplary embodiments. The method 200 is described with reference to the components illustrated in FIG. 1.

In block 205, the content distribution system 112 maintains a content repository 118. The content repository 118 includes a data structure, such as one or more databases and/or electronic records, that includes content to provide to a user based on information obtained from one or more of the user's receipts. The content can include advertisements, promotional offers, coupons, product brochures, training videos, information regarding product accessories or related products, product pricing information, digital products, merchant contact information, maps to merchant locations, a survey or form for requesting information, such as a product or service review, and other information related to products, merchants, or manufacturers. The content can be in the form of text, graphics, images, photograph, sound, video, web page files, a bar code, a quick response code (“QR code”), a jpeg, an mpeg, an mp3, and/or other multimedia and data files.

In certain exemplary embodiments, a receiver module 114 of the content distribution system 112 receives information that is included in the content repository 118 in electronic data feeds and/or a hard copy provided by one or more merchants 150, one or more product manufacturers 170, and/or another information source, such as a specialized information aggregator. For example, the merchant 150, the manufacturer 170, or another information source 180 may periodically provide batched or unbatched content in an electronic feed to the receiver module 114. In another example, the merchant 150, the manufacturer 170, or the information source 180 may provide content for a special promotion, such as seasonal sales event.

The receiver module 114 also may receive content from scanned product documentation, catalogs, coupons, advertisements, or other scanned documentation. In certain exemplary embodiments, the receiver module 114 also may receive the content from a screen scraping mechanism, which is included in or associated with the content distribution system 112. For example, the screen scraping mechanism may capture product information, pricing information, deals, promotions, coupons, or other information from merchant, manufacturer, or information provider websites.

In certain exemplary embodiments, the merchant 150 or manufacturer 170 can specify conditions for providing the content to a user. For example, a merchant 150 can specify that users that spend a total of $50 at that merchant 150 receive a coupon for $10 off their next purchase at that merchant 150. Likewise, a manufacturer 170 may specify that users that purchase a television marketed by a different manufacturer are offered a coupon to return the purchased television and buy a similar television offered by the manufacturer 170.

In block 210, the receipt module 131 receives an image. In certain exemplary embodiments, a user can execute the receipt module 131 at the user network device 130 and select an icon to capture an image. In response, the receipt module 131 can activate the camera 133. The user can use the camera 133 to take a picture of an object or a document, such as a paper receipt documenting a purchase transaction or an electronic receipt displayed on a screen. In certain exemplary embodiments, the user scans a paper document, such as a paper receipt, using the scanner 139. The user network device 131 can store an image file for the scanned image in the receipt repository 137 or another storage location. The user can navigate to a stored image file via a user interface of the receipt module 131. For example, the user can navigate to an image file for a scanned image stored in the receipt repository 137. In another example, the user may navigate to an image file of a receipt stored on or by a digital wallet 135 of the user network device 130.

In certain exemplary embodiments, the merchant 150 may provide a receipt or an image file having information to create an electronic image of the receipt electronically to the user. A point of sale (“POS”) device 155 of the merchant 150 may transmit a receipt or image file to the user network device 130 electronically via a wireless technology, such as Bluetooth or infrared or induction wireless. For example, the digital wallet 135 may interact with the POS device 155 via a wireless technology to complete the purchase of one or more products. After the transaction is completed, the POS device 155 can transmit a receipt or an image file for the receipt to the digital wallet 135. The digital wallet 135 can then store the receipt or image file in the receipt repository 137, at the digital wallet 135, or at another location. In certain exemplary embodiments, the merchant 155 sends a receipt or an image file for a receipt to the user via e-mail. The user can access the receipt or image file using an e-mail application and store the receipt or image file in the receipt repository 137 or at another location. The user can then navigate to and select from the receipts or image files stored on the end user network device 130 using the receipt module 131. The user also can navigate to and select from receipts and image files stored at a receipt repository 195 of the cloud computing environment 190 using the receipt module 131.

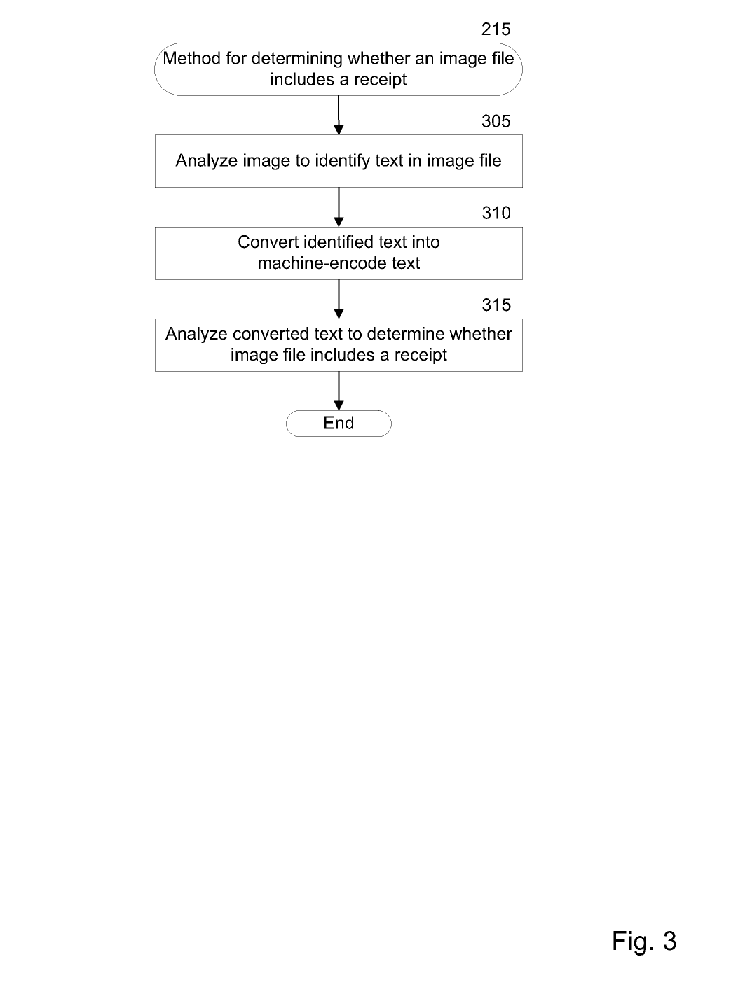

In block 215, the receipt module 131 analyzes the received image file to determine whether the image file includes a receipt documenting a prior purchase transaction. In certain exemplary embodiments, the receipt module 131 analyzes the image to identify any text in the image. For example, the receipt module 131 may use optical character recognition (“OCR”) to identify text in the image and convert the identified text into machine-encoded text. The receipt module 131 analyzes the converted text to determine whether the text indicates that the image includes a receipt. Block 215 is described in more detail hereinafter, with reference to FIG. 3.

In certain exemplary embodiments, a user can identify the image file as having a receipt. For example, a user may capture an image of a paper receipt using the camera 133. In response, the receipt module 131 may prompt the user to select whether an image file has or does not have a receipt.

If the receipt module 131 determines that the image file includes a receipt (or the user identifies the image file as having a receipt), the method 200 proceeds to block 230. Otherwise, the method 200 ends. Of course, additional images can be received and analyzed.

In block 225, the receipt module 131 stores the image file and/or the converted text from the image file in the receipt repository 137 of the user network device 130. In addition, or in the alternative, the receipt module 131 stores the image file and/or the converted text from the image file at the receipt repository 195 at the cloud computing environment 190. The user can later access the stored image file and converted text using the user network device 130 or another device connected to the cloud computing environment via the network 107.

In block 230, the receipt module 131 sends the converted text from the image file to the content distribution system 112 with a request for content. The request for content can be an explicit request made by the user, for example by actuating an icon displayed by the receipt module 131. The request for content can be an automatic request made by the receipt module 131 in response to determining that the image includes a receipt. In certain exemplary embodiments, the user can opt in or opt out of automatic requests.

The request for content can include a request for a particular type of content. For example, a user may actuate an icon displayed by the receipt module 131 to request coupons or deals. In another example, a user may actuate an icon to request the price of a product purchased and identified in the receipt at other merchants. In such a request, the receipt module 131 may interact with a global positioning system (“GPS”) module (or another location identification module) to identify the user's location and send information identifying the user's location along with the request for content. That way, the content distribution system 112 can search for merchants that offer the product near the user's location and return the price for the product at those merchants. In certain exemplary embodiments, the receipt module 131 is capable of being configured by the user to return certain types of content each time a request for content is made.

In block 240, the selection engine 116 selects content to return to the receipt module 131 based on the text from the image file having the receipt and the request for content. The selection engine 116 can select from content stored in the content repository 118. The selection engine 116 can consider any information and any combination of information obtained from the receipt to select content. This information can include, but is not limited to, product names, merchant names, manufacturer names, SKUs or other product identifiers, price paid for a product, total price paid, time and date of purchase, location of merchant where purchase was made, address identified in receipt, payment method used, and whether a coupon was used. For example, the selection engine 116 may select a promotional offer for use at a merchant based on the receipt indicating that the user spent a certain total amount at that merchant, as identified in the image file having the receipt.

In another example, the selection engine 116 may identify a list of merchants that carry one or more of the products identified in the receipt and the price for the product at those merchants. The selection engine 116 may also return a distance indicator that indicates the distance from the user to each of the merchants using GPS information from the end user network device 130 or an address for the user and the merchants' address. The receipt module 131 may display the merchants that offer the product(s) on a map making it convenient for the user to determine whether to visit another merchant. The user can use the pricing information to request that the merchant match the lowest price or to return the product and purchase the product from one of the other merchants. In certain exemplary embodiments, the identified list of merchants also includes online merchants and the price that the online merchants offer the product.

In another example, the selection engine 116 may search for content related to a purchased product, as identified in the receipt. For example, the selection engine 116 may identify coupons, promotional offers, or deals for a purchased product. The selection engine 116 also may identify additional products, such as accessories or complementary products for one or more purchased products, and select content related to the identified additional products. For example, the selection engine 116 may select a coupon for an online music service in response to the text from the receipt identifying the purchase of an MP3 player. In another example, the selection engine 116 may select a user manual, training video, or warranty document for a programmable thermostat in response to the text from the image of the receipt identifying the purchase of the thermostat.

In another example, the selection engine 116 may select content for a competing product that is similar to one or more products identified in the receipt. For example, the selection engine 116 may select a coupon or advertisement for a GPS device that is similar to a GPS device identified in the receipt, but offered by a different manufacturer.

In another example, the selection engine 116 may select certain content based on a time and/or date a purchase was made. For example, the selection engine 116 may identify from the receipt that a user purchased fuel from a particular gas station early in the morning. In response, the selection engine 116 may select a promotional offer for coffee at that particular gas station. If the selection engine 116 determines that the user purchased fuel in the evening, the selection engine 116 may select a promotional offer for a non-caffeinated beverage.

In another example, the selection engine 116 may select a survey or a form requesting information from a user. For example, if the selection engine 116 determines that a receipt is for a restaurant visit, the selection engine 116 may select a survey for the user to rate or review that restaurant. Information obtained from the user may be communicated to the restaurant or to an Internet website provider that provides reviews or ratings for restaurants.

In another example, the selection engine 116 may select a promotional offer or an advertisement for a manual service based on contents of a receipt. For example, if the selection engine 116 determines from a receipt that a user purchased fertilizer, the selection engine 116 may select a promotional offer for a lawn care service.

In certain exemplary embodiments, the content distribution system 112 also may access the user's prior receipts stored locally or at the cloud computing environment 190 and determine that the user has made a certain number of purchases or purchases totaling a certain amount from a merchant. In response, the selection engine 116 may select a promotional offer for the user's next visit to that merchant.

In certain exemplary embodiments, the selection engine 116 considers the geographic location of a user to select content. For example, if the selection engine 116 determines from a receipt that the user has recently purchased a video game system from a certain location, the selection engine 116 may select a coupon for a video game rental at a nearby location.

In certain exemplary embodiments, the selection engine 116 selects content based on the text from the image and the user's membership in one or more profiles. For example, activity reflected in a user's account records and prior receipts can be used to associate the user with one or more profiles as described in U.S. patent application Ser. No. 12/834,501, entitled “Distributing Content Based on Transaction Information,” and filed on Jul. 12, 2010. The entire contents of U.S. patent application Ser. No. 12/834,501 is hereby fully incorporated herein by reference. The selection engine 116 can associate users with profiles based on receipt information stored at the cloud computing environment 190 or at the information provider network device 110.

In certain exemplary embodiments, the selection engine 116 also considers information regarding the user, such as demographic information of the user, to select from available content in the content repository 118. In certain exemplary embodiments, the selection engine 116 involves an auction system that chooses between available content based on bid information, scheduling information, historical distribution information, and/or quality information.

In certain exemplary embodiments, the selection engine 116 requests content from merchants 150, manufacturers 170, or information sources 180 rather than selecting content from the content repository 118. For example, the selection engine 116 may recognize a product offered by a certain manufacturer 170 in the text from the image of the receipt. In response, the selection engine 116 may send a request to the manufacturer 170 for content to provide to the user.

In certain exemplary embodiments, all or a portion of the receipt module 131 is a part of the content distribution system 112. In such an embodiment, the user network device 130 can send an image file to the content distribution system 112 with a request for content. The receipt module 131 can then analyze the image file to determine whether the image includes a receipt and further analyze the identified receipt to select content to provide to the user.

In block 245, the content distribution system 112 sends the selected content to the receipt module 131. In block 250, the receipt module 131 presents the content to the user. The user can save the received content at the user network device 130 or at the cloud computing environment 190 for later use.

FIG. 3 is a block flow diagram depicting a method 215 for determining whether an image file includes a receipt, in accordance with certain exemplary embodiments, as referenced in block 215 of the method 200 of FIG. 2. In block 305, the receipt module 131 analyzes an image to identify text in the image file. In certain exemplary embodiments, the receipt module 131 uses OCR to identify text in the image file. In block 310, the receipt module 131 converts any identified text into machine-encoded text. The receipt module 131 may store the converted text at the end user network device 130.

In block 220, the receipt module 131 analyzes the converted text to determine whether the image contains a receipt of other transaction record or an indicator of a receipt or transaction record. For example, symbols that represent a currency, such as “$,” may indicate that the image includes a receipt. In addition, terms such as total, tax, tip, register, cashier, customer copy, a merchant name, credit card identifiers, and product identification numbers, such as a stock-keeping unit (“SKU”) may indicate that the image includes a receipt.

In certain exemplary embodiments, the receipt module 131 applies the converted text from the image file to a machine learning algorithm or another statistical model to determine whether the image includes a receipt. For example, a machine learning algorithm can be performed on receipts for one or more users to learn the structure of receipts and typical contents thereof. The machine learning algorithm can be installed as part of the receipt module 131 and used to determine whether images include a receipt based on the identified content extracted from the receipt. The machine learning algorithm can be updated periodically. In certain exemplary embodiments, the receipt module 131 assigns a score to the image based on the analysis and determines that the image includes a receipt if the score assigned to the image meets or exceeds a threshold score.

### Example

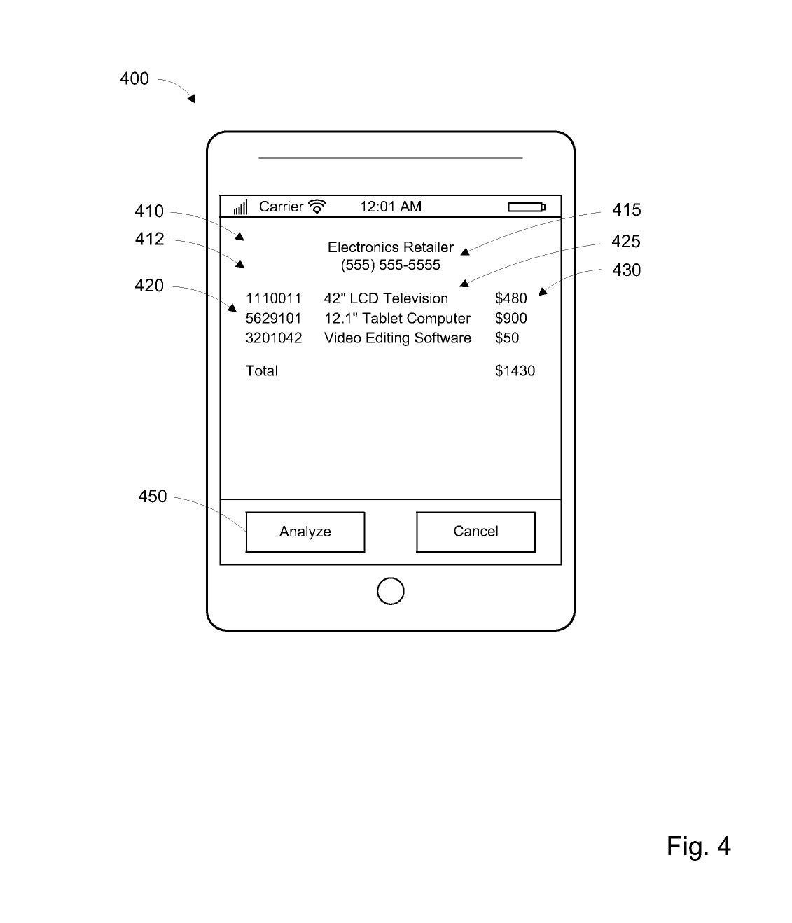

To illustrate the operation of one embodiment of the system 100 and the method 200, an example is provided in FIGS. 4-8. The example disclosed herein is not intended to limit the scope of the foregoing disclosure, and instead, is provided solely to illustrate one particular embodiment as it relates to one specific receipt 412.

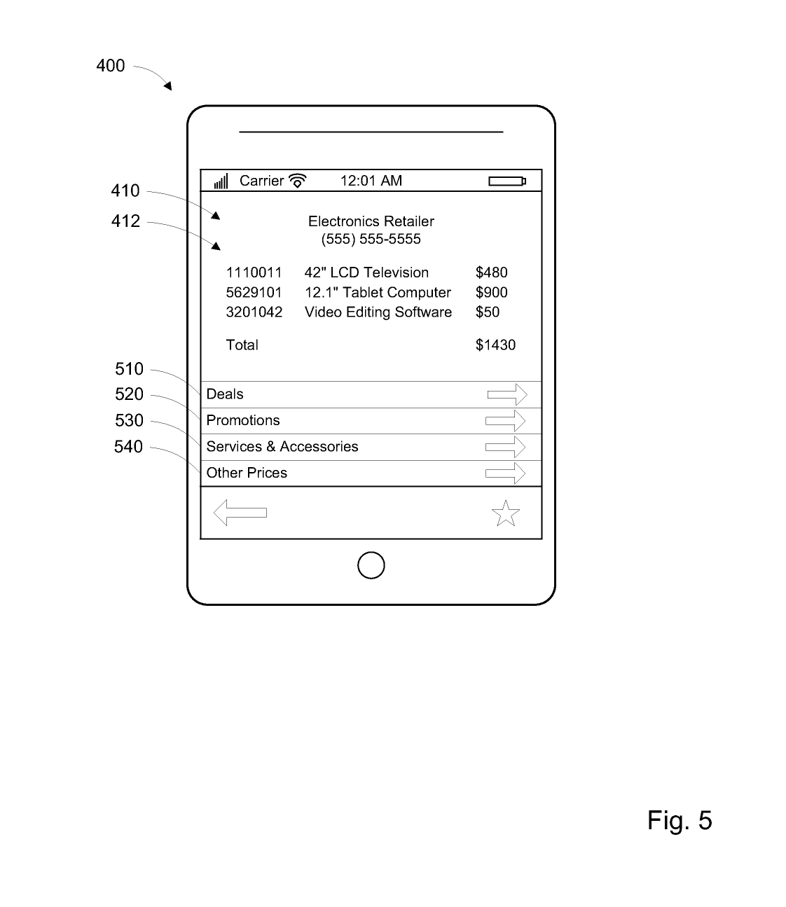

FIG. 4 is a block diagram depicting an end user network device 400 displaying an image 400 of the receipt 410, in accordance with certain exemplary embodiments. Referring to FIGS. 1 and 4, the exemplary receipt 412 includes a merchant, “Electronics Retailer,” and three purchased items, each including a product identifier 420, a product description 425, and a purchase price 430. In particular, the receipt 412 identifies a 42″ LCD Television,” a “12.1” Tablet Computer,” and “Video Editing Software.” A user can actuate an “Analyze” icon 450 to command the receipt module 131 to analyze the image 410 to determine whether the image 410 includes a receipt 412. In response to determining that the image 410 includes the receipt 412, the receipt module 131 can display one or more icons 510-530 (FIG. 5) for the user to request additional content or request additional content automatically.

FIG. 5 is a block diagram depicting the end user network device 400 displaying the image 410 of the receipt 412 and a multitude of icons 510-530 for requesting additional content. Referring now to FIGS. 1, 4, and 5, the receipt module 131 displays the icons 510-530 in response to the user actuating the analyze icon 450 and the receipt module identifying the receipt 412 in the image 410. A user can actuate the “Deals” icon 510 to request deals or coupons related to products identified in the receipt 412. The user can actuate the “Promotions” icon 520 to request promotions related to products identified in the receipt 412. The user can actuate the “Services and Accessories” icon 530 to request services and/or accessories for the products identified in the receipt 312. The user can actuate the “Other Prices” icon 540 to request prices of one or more products identified in the receipt 412 (or similar thereto) at other merchants. In response to one of the icons 510-530 being actuated, the receipt module 131 extracts information from the receipt 412 and sends the extracted information along with a request for content to the content distribution system 112. The content distribution system 112 can select content based on the received information and the request and return the selected content to the receipt module 131 for presentation to the user.

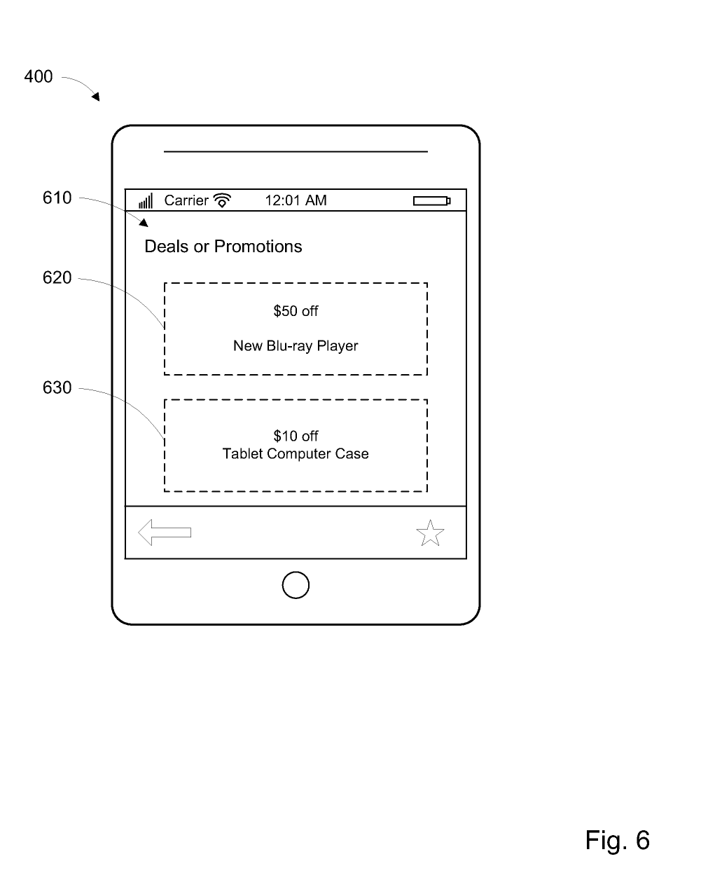

FIG. 6 is a block diagram depicting the end user network device 400 displaying a deals or promotions screen 610, in accordance with certain exemplary embodiments. Referring now to FIGS. 1 and 6, the deals or promotions screen 610 includes a coupon 620 for a new Blu-ray disc player and a coupon 630 for a tablet computer case. These coupons 610 and 620 may be selected by the content distribution system 112 in response to the receipt 412 identifying the purchase of a television and a tablet computer. As would be appreciated by one of ordinary skill in the art, many other coupons, deals, or promotions may be provided to the user based on the purchase of a television and a tablet computer.

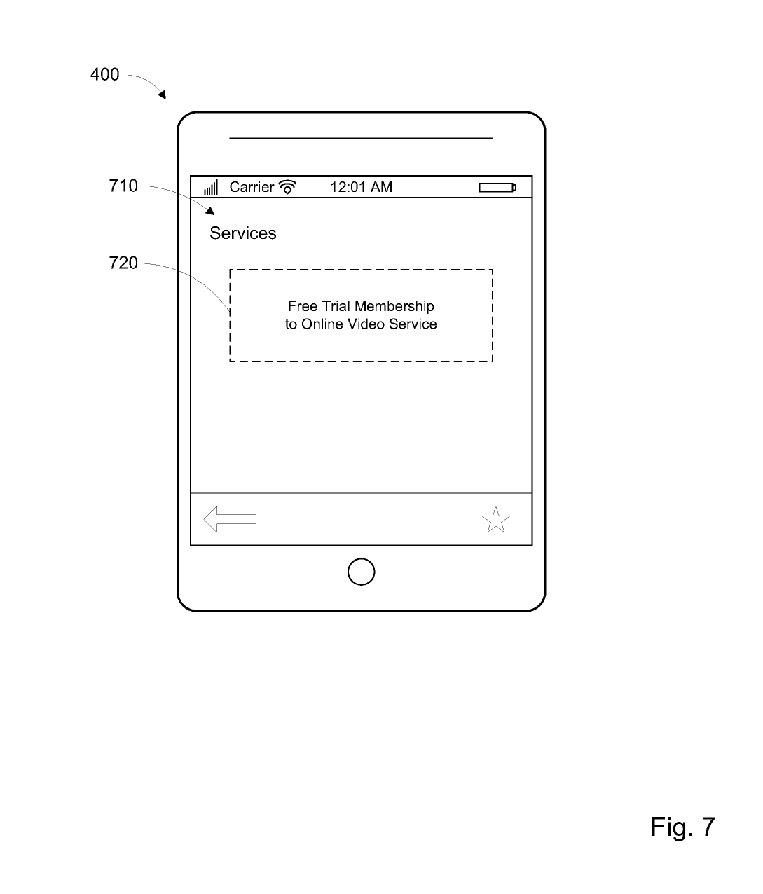

FIG. 7 is a block diagram depicting the end user network device 400 displaying a services screen 710, in accordance with certain exemplary embodiments. Referring now to FIGS. 1 and 7, the services screen 710 includes an advertisement 720 for a free trial membership to an online video service. This advertisement 720 may be selected by the content distribution system 112 in response to the receipt 412 identifying the purchase of a television and a tablet computer. As would be appreciated by one of ordinary skill in the art, many other advertisements for services may be provided to the user based on the purchase of a television and a tablet computer.

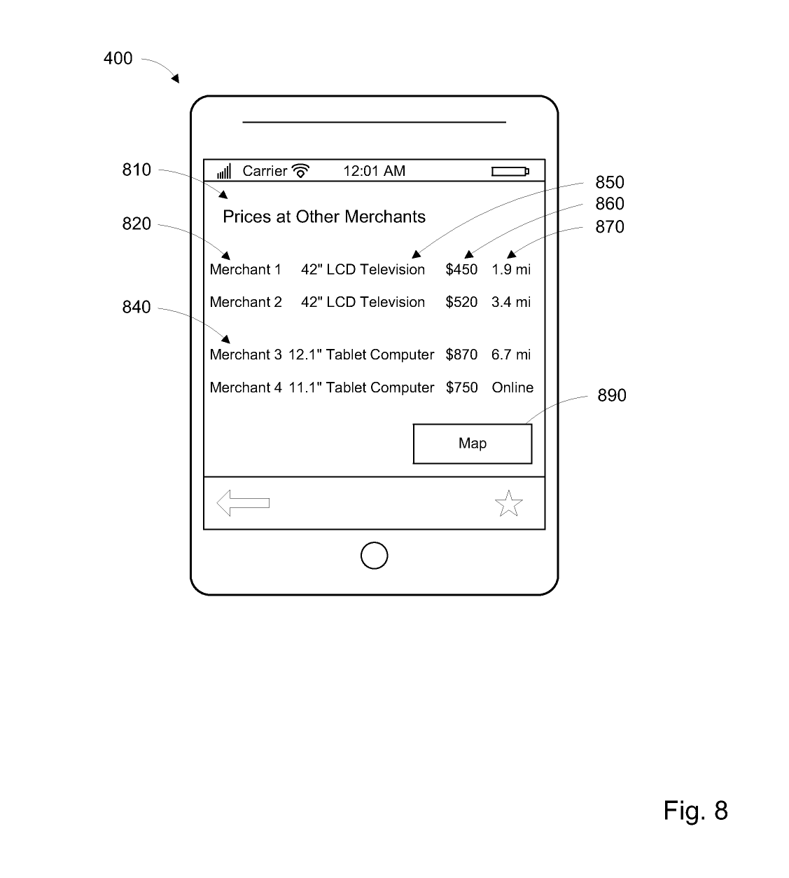

FIG. 8 is a block diagram depicting an end user network device 400 displaying prices of products at other merchants screen (“prices screen”) 810, in accordance with certain exemplary embodiments. Referring now to FIGS. 1 and 8, the prices screen 810 displays the price 860 of products identified in the receipt 412 (or related products or product accessories) at other merchants 820, 840. In particular, the exemplary prices screen 810 includes information regarding two merchants 820, “Merchant 1” and “Merchant 2,” that each offer a 42″ LCD Television and two merchants 840, “Merchant 3” and Merchant 4,” that each offer a Tablet Computer. The information regarding the merchants 820, 840 in this example include a product description 850, the price 860 at that merchant 820, 840, and a distance 870 from the end user network device 400 to a location of the merchant 820, 840.

The content distribution system 112 can return information, including pricing information, regarding identical products and related products or accessories. For example, Merchant 1 and Merchant 2 may both offer 42″ LCD Televisions that are identical to the 42″ LCD Television identified in the receipt 412. Also, Merchant 3 may offer a 12.1″ Tablet Computer that is identical to the 12.1″ Tablet Computer identified in the receipt 412, while Merchant 4 offers a similar 11.1″ Tablet Computer.

The content distribution system 112 can search for merchants 820, 840 that are near the end user network device 400 and online merchants that offer a product identified in the receipt 412 or a related product or product accessory. For example, Merchant 4 is an online merchant that offers products via the Internet rather than via a retail store. The content distribution system 112 may return the price (or other information) of a product identified in the receipt at a merchant's retail store and the price at that same merchant's Internet website.

The exemplary prices screen 810 also includes a map icon 890. The user can actuate the map icon 890 to display the merchants 820, 840 displayed on the prices screen 810 on a map. The receipt module 131 or the content distribution system 112 can access information identifying the location of the end user network device 400, such as GPS information or address information, and the address for the merchants 820, 840. The receipt module 131 or the content distribution system 112 can use this location information to display the locations of the merchants 820, 840 and optionally the location of the end user network device 400 on a map.

### General

The exemplary methods and blocks described in the embodiments presented previously are illustrative, and, in alternative embodiments, certain blocks can be performed in a different order, in parallel with one another, omitted entirely, and/or combined between different exemplary methods, and/or certain additional blocks can be performed, without departing from the scope and spirit of the invention. Accordingly, such alternative embodiments are included in the invention described herein.

The invention can be used with computer hardware and software that performs the methods and processing functions described above. As will be appreciated by those having ordinary skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

Although specific embodiments of the invention have been described above in detail, the description is merely for purposes of illustration. Various modifications of, and equivalent blocks corresponding to, the disclosed aspects of the exemplary embodiments, in addition to those described above, can be made by those having ordinary skill in the art without departing from the spirit and scope of the invention defined in the following claims, the scope of which is to be accorded the broadest interpretation so as to encompass such modifications and equivalent structures.

What is claimed is:

1. A computer-implemented method to cause a mobile computing device to render a user interface that dynamically presents content that is selected based on an analysis of an image by performing an optical character recognition process on the image and extracting converted text from the image, comprising:
capturing, by a camera on a mobile computing device, an electronic image;
associating, by the mobile computing device, a geolocation with the image, the mobile computing device monitoring locations of the mobile computing device and automatically detecting a location of the mobile computing device at a time when the camera captures the image, the geolocation comprising the location of the mobile computing device at the time when the camera captured the image;
analyzing, by the mobile computing device, the image by:
performing an optical character recognition process on the image,
extracting information from converted text of the image, and
determining the geolocation associated with the image;
transmitting, by the mobile computing device, the extracted information, the geolocation, and a request for content to a content distribution computing system, the content distribution computing system determining content to select for transmission to the mobile computing device by analyzing the extracted information, the geolocation, and the request for content;
receiving, by the mobile computing device, a content alert notification from the content distribution computing system, the content alert notification causing a content alert to display on a user interface of the mobile computing device; and
rendering, by the mobile computing device, the user interface to present content available near the geolocation when the content alert is selected.

2. The method of claim 1, wherein the request for content comprises a request for a particular type of content, and the content distribution computing system analyzes the request for content to determine content of the particular type of content to select for transmission to the mobile computing device.

3. The method of claim 1, wherein the extracted information, the geolocation, and the request for content are transmitted to the content distribution computing system in response to selection of an object rendered on the user interface of the mobile computing device, the object actuated to initiate the transmission of the extracted information, the geolocation, and a request for content to the content distribution computing system.

4. The method of claim 1, wherein the user interface is rendered to display a map that presents the content available near the geolocation.

5. The method of claim 1, wherein the user interface is rendered to display a listing of the content available near the geolocation each with a distance indicator, the distance indicator comprising a distance between the geolocation and a location of the content.

6. The method of claim 1, wherein performing the optical character recognition process on the image comprises:
analyzing, by the mobile computing device, the image to identify the converted text in the image; and
converting, by the mobile computing device, the identified text from the image into machine-encoded text.

7. The method of claim 1, further comprising applying, by the mobile computing device, a machine learning process to the converted text.

8. The method of claim 1, further comprising assigning, by the mobile computing device, a score to the image.

9. The method of claim 8, further comprising determining, by the mobile computing device, that the score assigned to the image meets or exceeds a threshold score.

10. The method of claim 1, wherein the content distribution computing system selects the content for transmission to the mobile computing device from a content repository maintained by the content distribution computing system.

11. The method of claim 1, wherein the content distribution computing system further determines that content transmission requirements for the content have been met prior to transmitting the selected content to the mobile computing device.

12. A system to render a user interface to dynamically present content that is selected based on analysis of an image by performing an optical character recognition process on the image and extracting converted text from the image, comprising:
a mobile computing device, comprising:
a storage device,
a user interface that is rendered to dynamically present content,
a camera that captures an electronic image,
a location device that associates a geolocation with the image, the location device monitoring locations of the mobile computing device and detecting a location of the mobile computing device at a time when the camera captures the image, the geolocation comprising the location of the mobile computing device at the time when the camera captured the image, and
a processor that analyzes the image by performing an optical character recognition process on the image, extracting information from converted text of the image, and determining the geolocation associated with the image; and
a content distribution computing device that receives the extracted information, the geolocation, and a request for content from the mobile computing device, determines content for transmission to the mobile computing device by analyzing the extracted information, the geolocation, and the request for content, and transmits a content alert notification to the mobile computing device,
the content alert notification causing a content alert to display on the user interface of the mobile computing device, and
the user interface on the mobile computing device rendered to present the selected content that is available near the geolocation when the content alert is selected.

13. The system of claim 12, wherein the user interface is rendered to display a map that presents the content available near the geolocation.

14. The system of claim 12, wherein the user interface is rendered to display a listing of the content available near the geolocation each with a distance indicator.

15. The system of claim 12, wherein the mobile computing device assigns a score to the image and determines whether the score assigned to the image meets or exceeds a threshold score.

16. The system of claim 12, wherein the content distribution computing system further determines that content transmission requirements for the content have been met prior to transmitting the selected content to the mobile computing device.

17. A computer program product, comprising:
a non-transitory computer-readable medium having computer-executable program code embodied thereon that when executed by a mobile computing device cause the mobile computing device to render a user interface to dynamically present content that is selected based on analysis of an image by performing an optical character recognition process on the image and extracting converted text from the image, comprising:
computer-executable program code to capture an electronic image;
computer-executable program code to associate a geolocation with the image, a mobile computing device monitoring locations of the mobile computing device and detecting a location of the mobile computing device at a time when the image is captured, the geolocation comprising the location of the mobile computing device at the time when the image is captured;
computer-executable program code to analyze the image by performing an optical character recognition process on the image, extracting information from converted text of the image, and determining the geolocation associated with the image;
computer-executable program code to transmit the extracted information, the geolocation, and a request for content to a content distribution computing system, the content distribution computing system determining content to select for transmission to the mobile computing device by analyzing the extracted information, the geolocation, and the request for content;
computer-executable program code to receive a content alert notification from the content distribution computing system, the content alert notification causing a content alert to display on a user interface on the mobile computing device; and
computer-executable program code to render the user interface on the mobile computing device to present content that is available near the geolocation when the content alert is selected.

18. The computer program product of claim 17, wherein the user interface is rendered to display a map that presents the content available near the geolocation.

19. The computer program product of claim 17, further comprising computer-executable code to assign a score to the image and determine whether the score assigned to the image meets or exceeds a threshold score.

20. The computer program product of claim 17, further comprising computer-executable program code to apply a machine-learning process to the converted text.
